(19) United States
(12) Patent Application Publication
(10) Pub. No.: US 2009/0215015 A1
(43) Pub. Date: Aug. 27, 2009

(54) Method and Apparatus for Developing a Proper Tooth Brushing Technique

(75) Inventor: Hao-Hua Chu, Taipei (TW)

Correspondence Address: GENE I. SU, XIN YI RD., SECTION 4, NO. 151, 17F-1, TAIPEI, TW

(73) Assignee: RAINDROP NETWORK LTD., Taipei (TW)

(21) Appl. No.: 12/034,844

(22) Filed: Feb. 21, 2008

(51) Int. Cl. G09B 19/00; G09B 23/28

(52) U.S. Cl. 434/238; 434/263

(57) ABSTRACT

One embodiment of the present invention includes a signaling device capable of assisting a child to develop a tooth brushing technique. The signaling device includes a toothbrush and an extension device, which is affixed to the tooth brush. The extension device is coded with a plurality of patterns that can be converted into motion and orientation information associated with the tooth brush in a tooth brushing session, and the motion and orientation information is further compared to a predetermined set of expected conditions that correspond to the tooth brushing technique to determine a reward tailored to promote learning of the tooth brushing technique.

### BACKGROUND OF THE INVENTION

1. Field of the Invention

The present invention relates generally to assistive systems, especially a method and apparatus for developing a proper tooth brushing technique.

2. Description of the Related Art

Developing a proper tooth brushing technique and routine is important during a child's growth period. A proper brushing technique ensures healthy oral hygiene for the child. However, it has been known that young children typically have a short attention span and do not like to brush their teeth because tooth brushing is not considered fun. In addition, children often view the time spent on brushing teeth conflicts with their playing time. For at least the reasons mentioned above, it is difficult for young children to develop a routine to brush their teeth properly and thoroughly. Although the parents may utilize some conventional auxiliary tools to try to teach their children the proper routine, these conventional auxiliary tools, which are discussed below, are mostly ineffective.

The American Dental Association (“ADA”) has recommended a proper brushing routine for different groups of teeth. For example, the outer and inner tooth surfaces should be brushed with a back and forth circular motion, and the chewing surfaces of the teeth should be cleaned by holding the brush flat and moving in a backward and forward motion. Auxiliary tools are designed to help developing such a tooth brushing routine. Some examples include the sugary toothpaste from Colgate and the music-rewarding ToothTune toothbrush from Hasbro. Although these auxiliary tools on the market may attract a child's interest in tooth brushing, but they still fall short of encouraging or motivating a child to brush properly and thoroughly. Thus, what is needed is a way to guide a child to adopt a proper behavioral pattern, such as a proper tooth brushing technique, and address at least the problems set forth above.

### SUMMARY OF THE INVENTION

A method and apparatus for developing a proper tooth brushing technique is disclosed. Specifically, one embodiment of the present invention includes a signaling device capable of assisting a child to develop a tooth brushing technique. The signaling device includes a toothbrush and an extension device, which is affixed to the tooth brush. The extension device is coded with a plurality of patterns that can be converted into motion and orientation information associated with the tooth brush in a tooth brushing session, and the motion and orientation information is further compared to a predetermined set of expected conditions that correspond to the tooth brushing technique to determine a reward tailored to promote learning of the tooth brushing technique.

At least one advantage of the present invention disclosed herein is to maintain the needed interest level in a child for a sufficient amount of time so that he or she has an opportunity to learn and acquire a desired tooth brushing technique.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the drawings. It is to be noted, however, that the drawings illustrate only typical embodiments of this invention and are therefore not to be considered limiting of its scope, for the invention may admit to other equally effective embodiments.

FIG. 1 is a conceptual diagram of a feedback reward model, according to one embodiment of the present invention;

FIG. 2 is simplified block diagram of an assistive system configured to implement the feedback reward model shown in FIG. 1, according to one embodiment of the present invention;

FIG. 3 illustrates a particular implementation of the assistive system shown in FIG. 2, according to one embodiment of the present invention;

FIG. 4A is a schematic diagram illustrates a signaling device, according to one embodiment of the present invention;

FIG. 4B is a simplified schematic diagram illustrating the arrangements of the LEDs on all four extension faces of the extension device shown in FIG. 4A, according to one embodiment of the present invention;

FIG. 5A is a diagram showing a set of teeth divided into twenty-four brushing areas;

FIG. 5B illustrates representations of certain elements of a brushing stroke in a three-dimensional coordinate system, according to one embodiment of the present invention;

FIG. 6A illustrates some display output images of an interactive game, according to one embodiment of the present invention; and

FIG. 6B is a flow chart illustrating a process that the assistive system of FIG. 3 follows, according to one embodiment of the present invention.

### DETAILED DESCRIPTION

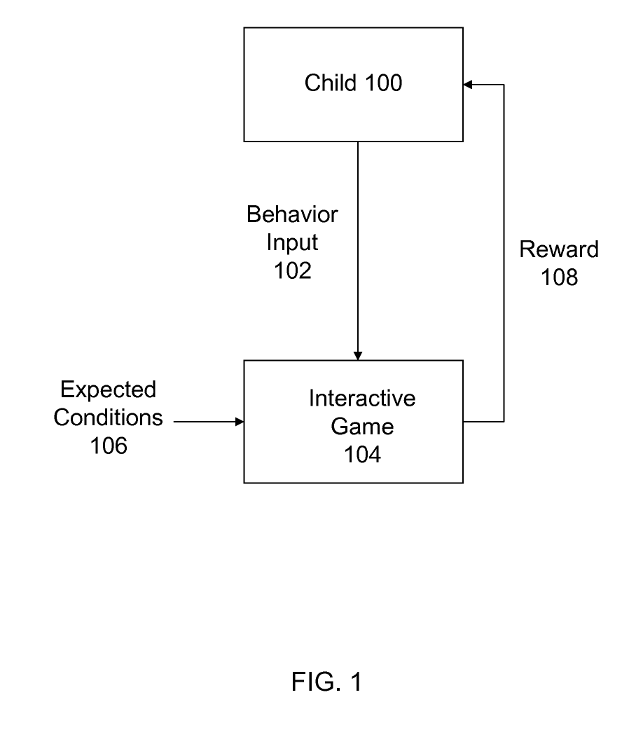

During a child's growth period, a child's behavioral pattern may be modified by using assistive means, such as an interactive game capable of providing feedback reward to a child. FIG. 1 is a conceptual diagram of a feedback reward model, according to one embodiment of the present invention. The model involves a behavioral input 102 from a child 100, an interactive game 104, expected conditions 106, and a reward 108. The interactive game 104 can be used to attract the attention of the child 100 and encourage the child 100 to develop a particular behavioral pattern. In this model, the interactive game 104 is configured with a number of expected conditions 106, which may be associated with a set of rules or guidelines associated with a behavioral pattern. For instance, the expected conditions 106 can correspond to a set of tooth brushing steps that follow the ADA recommendations. An administrator of the interactive game 104, who is usually the person looking after the child 100, often decide what the expected conditions 106 should be. In addition, the interactive game 104 is configured to receive the behavioral input 102. The behavioral input 102 here is derived from events or conditions detected by an assistive system, such as a toothbrush with an extension, after filtering out the noises associated with such events or conditions (e.g., the child pretends to brush teeth by waving the toothbrush in the air).

To help the child 100 develop a desired behavioral pattern, one of the steps the interactive game 104 performs is to compare the behavioral input 102 of the child 100 with the expected conditions 106. If the behavioral input 102 matches a certain threshold associated with the expected conditions 106, then the reward 108 issued by the interactive game 104 is a positive reward. Alternatively, rather than using the positive reward to encourage the child 100, the reward 108 can be a negative reward to discourage the child 100 from continuing his or her actions. By embedding a desired behavioral pattern in the interactive game 104 and through the issuance of the reward 108, the interactive game 104 not only attracts the attention of the child 100 but also familiarizes the child 100 with the desired behavioral pattern.

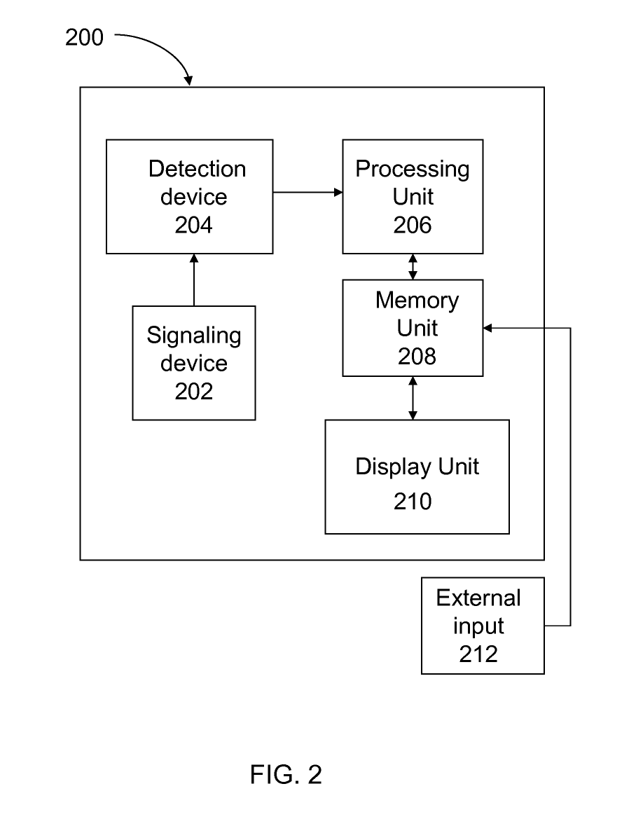

FIG. 2 is simplified block diagram of an assistive system 200 configured to implement the feedback reward model shown in FIG. 1, according to one embodiment of the present invention. The assistive system 200 includes a signaling device 202, a detection device 204, a processing unit 206, a memory unit 208, a display unit 210, and an external input 212. The detecting device 204 is configured to detect and interpret characteristics information generated by the signaling device 202, such as the position or motion information associated the signaling device 202, within the detection range of the detection device 204. This detection range may be a pre-determined range. The processing unit 206 receives the detected characteristics information from the detection device 204. The processing unit 206 is configured to process the information, such as converting detected information into behavioral input data, and execute the interactive game based on the behavioral input data and the expected conditions stored in the memory unit 208. As mentioned above, these expected conditions generally correspond to desired behavioral patterns and may be stored in the memory unit 208. The memory unit 208 may be, without limitation, a storage device embedded in the assistive system 200 or a portable storage device, such as a Universal Serial Bus (USB) memory stick, a portable hard drive, or a memory card. The display unit 210 is used to display the output of the interactive game. The external input 212 is an interface enabling additional expected conditions to be programmed into the memory unit 208. Examples of the external input 212 include, without limitation, a wired connection, such as a Universal Serial Bus (USB) connection and an IEEE1394 cable, and a wireless connection utilizing technologies such as Bluetooth and Wi-Fi.

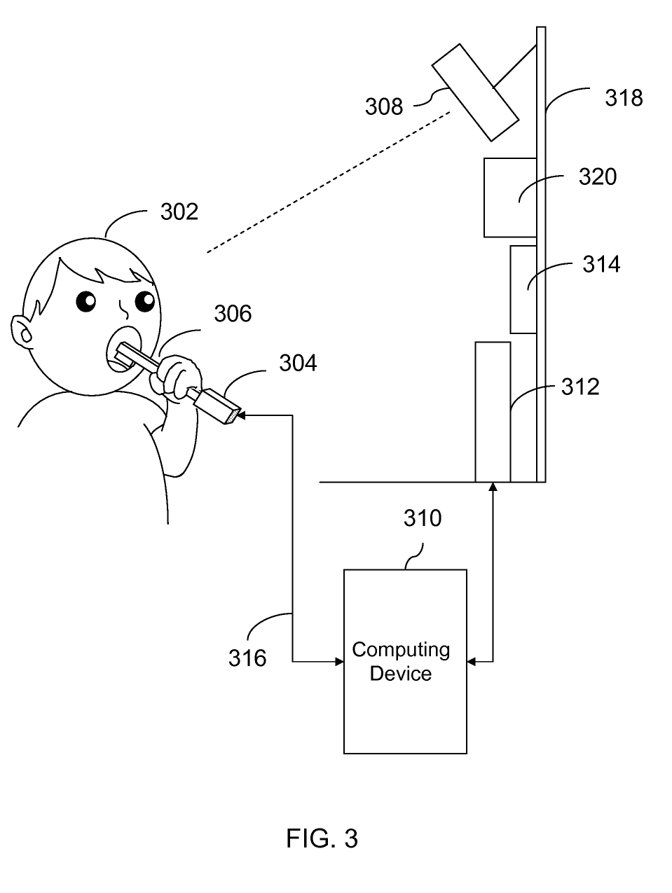

When parents want to help their child to develop a proper tooth brushing technique, they may use a particular implementation of the assistive system 200, such as the assistive system shown in FIG. 3. Here, a child 302 uses a toothbrush 306, which is coupled to an extension device 304. Both the extension device 304 and the toothbrush 306 collectively correspond to the signaling device 202 of FIG. 2. In addition, a camera 308 is placed above the child 302 and serves as the detection device 204 of FIG. 2. A computing device 310 with a processing unit and an external input is configured to execute an interactive game and display the output of the interactive game on a display device 312. The computing device 310 can be a portal device with processing capabilities, such as a cellular phone, a personal digital assistant (PDA), a laptop computer, and the display device 312 can either be external to the computing device 310 as shown or be integrated as a part of the computing device 310. The child 302 is within the detection range of the camera 308 and can see himself or herself brush teeth in a mirror 314 on a wall 318. The extension device 304 is coupled to the computing device 310 via a connection 316. Suppose the child 302 holds the toothbrush 306 in his or her hand and brushes teeth while watching certain video images generated by the interactive game on the display device 312. The camera 308 is configured to capture the motion and the orientation of the toothbrush 306 as the child 302 brushes his or her teeth, so long as the child 302 is within the detection range of the camera 308. In one implementation, the camera 308 is tilted with respect to the wall 318 and preferably points at the general direction of the child 302. Since the child 302 is unlikely to brush his or her teeth in a recommended sequence right away, in one implementation, the system shown in FIG. 3 further includes a supplemental detection device 320 with recording capabilities to record the tooth-brushing sequences of the child 302 for future analysis. The recorded information allows a researcher, a therapist, a dentist, or others to conduct non-real time behavioral analysis or even help identify possible causes for certain dental problems or diseases suffered by the child 302.

To allow the camera 308 to capture the relevant motion and orientation information associated with the toothbrush 306, in one implementation, the surfaces of the extension device 304 are implanted with Light Emitting Diode (LED) markers in different predetermined colors arrangements. The camera 308 captures the colors, locations, and the arrangement of these LED markers on the extension device 304 for the computing device 310 to extract motion and orientation information of the extension device 304 and the toothbrush 306. A detailed description of the extension device 304 and how the information captured by the camera 308 is interpreted will be provided in subsequent paragraphs. The computing device 310 processes the captured information and converts it into behavioral input data. The computing device 310 then compares the behavioral input data with a set of expected conditions, such as the ADA recommended tooth brushing routine. The interactive game takes in the compared results and presents certain feedback information, such as rewards, back to the child 302 through the display device 312. Regardless of whether the rewards are positive or negative, they are presented to the child 302 to help the child learn and adopt the tooth brushing routine.

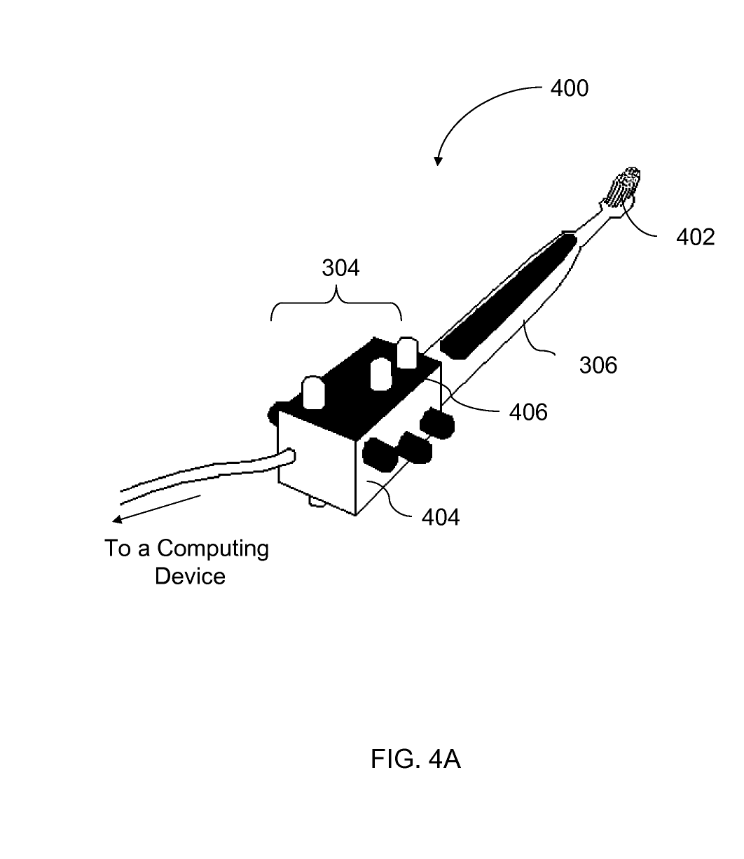

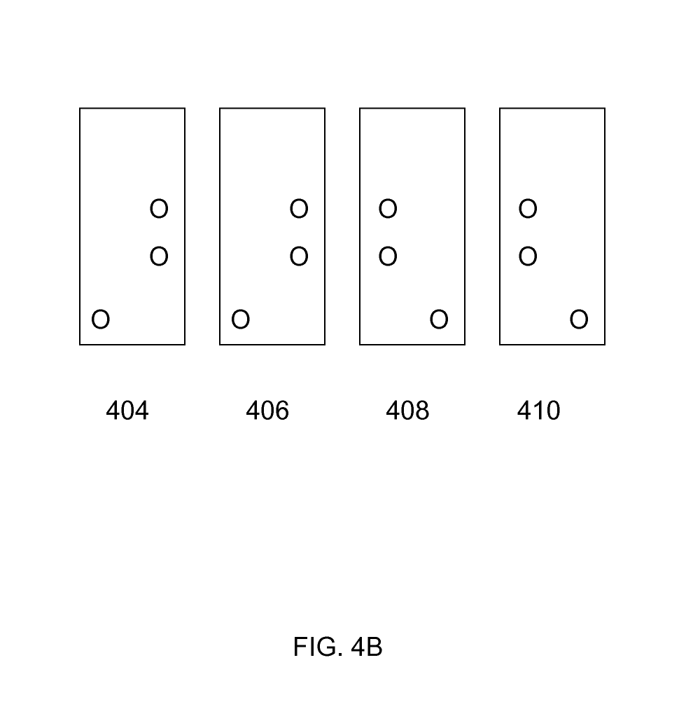

FIG. 4A is a schematic diagram illustrates a signaling device 400, according to one embodiment of the present invention. The signaling device 400 includes the toothbrush 306 and the extension device 304 shown in FIG. 3. The toothbrush 306 includes bristle 402. The signaling device 400 is electronically connected to a computing device, such as the computing device 310 of FIG. 3, via either a wired or a wireless connection. The surfaces of the extension device 304 are coded with certain distinguishable patterns. In one implementation, four sets of LEDs (only two of which, residing on extension faces 404 and 406, are shown in the figure) are placed on four extension faces of the box-shaped extension device 304. Each set of LEDs with a predetermined color is placed at a predetermined location on the extension face of the extension device 304. The colors, locations, and arrangements of the LEDs on the extension faces are configured to be distinguishable from each other from the perspective of a detection device, such as the camera 308 of FIG. 3. The extension device 304 preferably is of light weight as well as water-proof to prevent water from entering into the extension device to short-circuit the LEDs.

It is important that the camera 308 captures the patterns, such as the various attributes of the LEDs, so that the relevant motion or orientation information associated with the signaling device 400 can be derived. To reduce the likelihood of the child blocking the LEDs from the view of the camera 308 by holding the extension device 304 instead of the toothbrush 306, in one implementation, a circular plate (not shown) wider than the extension device 304 is placed between the toothbrush 306 and the extension device 304 as a separator to prevent the child from holding and blocking the extension device 304 from the camera 308.

FIG. 4B is a simplified schematic diagram illustrating the arrangements of the LEDs on all four extension faces 404, 406, 408, and 410 of the extension device 304 of FIG. 4A, according to one embodiment of the present invention. In one implementation, the set of LEDs on the extension face 404 is configured to emit green light and is arranged in a clockwise manner. Other sets of the LEDs on the extension faces 406, 408, and 410 are configured to emit yellow, green, and yellow lights, and are arranged in clockwise, counter-clockwise, and counter-clockwise fashions, respectively. In one implementation, when the child holds the toothbrush 306 in an orientation such that the child faces the bristle 402, the child also faces the extension face 404 of the extension device 304. In other words, in conjunction with FIG. 3, if the extension face 404 faces the child 302, then only the extension faces 406, 408, and 410 are visible to the camera 308, since the camera 308 points generally at the child 302. In short, the location of the camera 308 and the arrangements of the LEDs on the extension faces of the extension device 304 are configured to enable the computing device 310 to determine the orientation and the motion of the toothbrush 306 from the image data captured by the camera 308. It is worth noting that other combinations of colors, locations, and arrangements of the LEDs than the combinations discussed above can be utilized without exceeding the scope of the present invention.

The computing device 310 of FIG. 3 is configured to recognize and differentiate among various brushing strokes from the image data captured by the camera 308. In one implementation, the image data is first filtered to keep as much of the information relevant to the coded patterns of the extension device 304 shown in FIG. 4A and FIG. 4B as possible. For instance, any excessively dim or bright pixels from the image data are filtered out, since they are unlikely to be produced by the LED light sources on the extension device 304. Then, the filtered image data are organized to correlate to the patterns on the surfaces of the extension device 304. For example, after retrieving the color and location information of the LEDs from the filtered image data, a corresponding extension face of the extension device 304 can be identified.

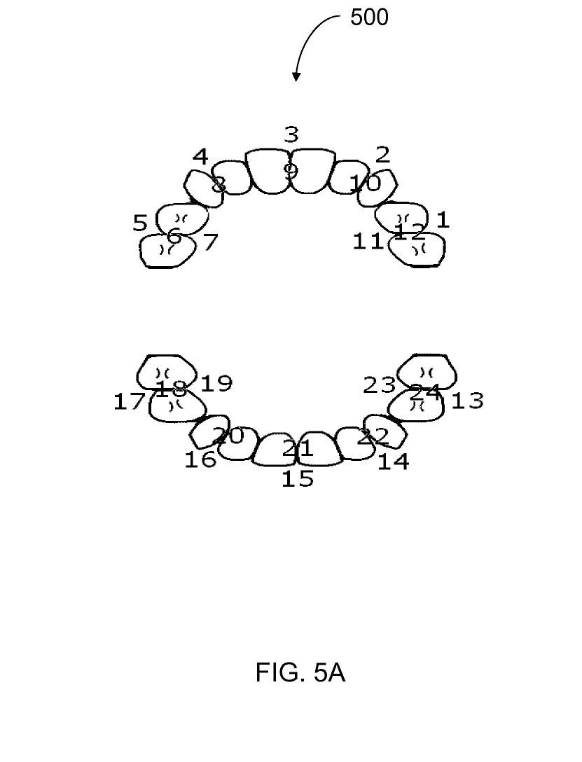

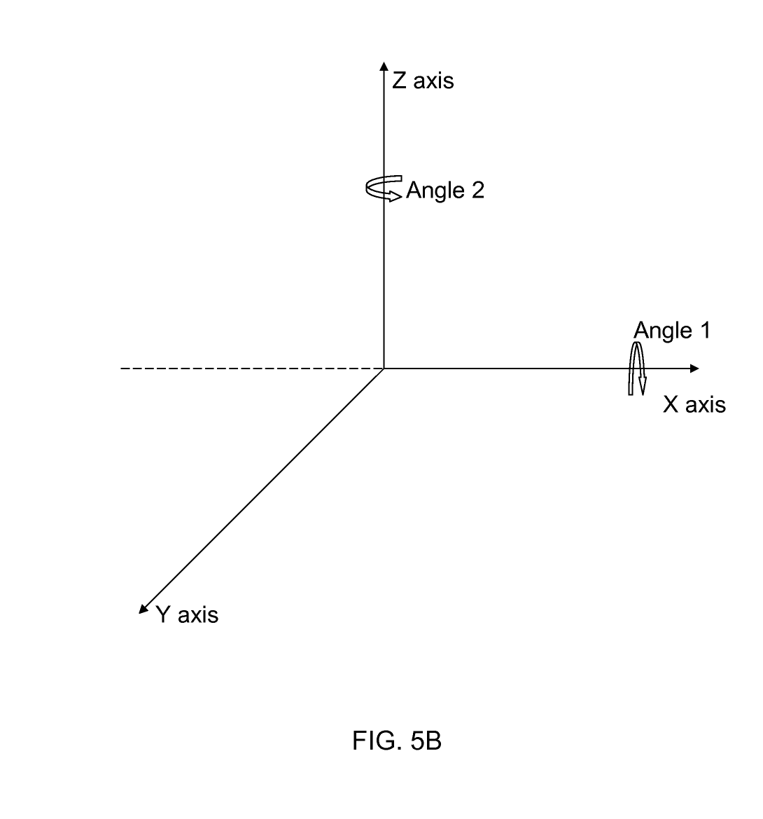

It should be noted that each brushing stroke can be broken down into several elements derivable from the determined extension faces, such as a first angle rotating about the x axis, a second angle rotating about the z axis, and a brush movement and motion vector. To illustrate how the brushing strokes are interpreted and analyzed, FIG. 5A is a diagram showing a set of teeth divided into twenty-four brushing areas, and FIG. 5B illustrates representations of certain elements of a brushing stroke in a three-dimensional coordinate system, according to one embodiment of the present invention. Specifically, since the teeth-bristle contact area is not externally visible during brushing, the bristle rotation and brush orientation angles are combined to infer the motion required to brush a specific teeth-bristle contact area. For example, in conjunction with FIG. 4A, brushing the biting surface of the maxillary molars (teeth area 6 in FIG. 5A) requires (1) holding the bristle 402 upward at the first angle equaling to approximately 90 degrees and (2) turning the toothbrush 306 on the flat plane at the second angle between approximately 80 and 150 degrees. In addition to the first and the second angles, the toothbrush 306 is moved back and forth with a certain brush motion vector displacement and a direction of the brush motion vector. To determine the displacement and the direction of the brush motion vector, one implementation is to compare the locations of the LEDs in a first frame of the image data captured by the camera 308 with the locations of the LEDs in a second frame of the image data also captured by the camera 308. The first frame and the second frame are captured at different times. The brush motion vector displacement together with the direction of the brush motion vector enable the computing device 310 to extract the motion information associated with the signaling device 400.

It should be noted that the angle degrees discussed above for the first angle and the second angle are from the perspective of the camera 308 of FIG. 3. Since the camera 308 is typically tilted relative to the wall 318, in an alternative implementation, the image data captured by the camera 308 is adjusted to take into account of the tilt, so that the angles are adjusted to conform to the global three-dimensional coordinate system before additional processing occurs. For example, if the first angle is at 90 degrees from the camera coordinate system, then it may be adjusted to be (90-n degrees) in the global three-dimensional coordinate system, wherein the n degrees reflect the amount of tilt of the camera 308 relative to the wall 318.

Moreover, one implementation of the computing device 310 also tracks the number of brush strokes of the signaling device 400. In addition to ensuring each of the brushing areas shown in FIG. 5A is brushed, it may also be important to ensure sufficient time is spent to thoroughly clean the brushing area. Thus, the computing device 310 may track whether the number of the brush strokes meets a predetermined threshold.

It should be apparent to a person with ordinary skills in the art to calibrate the assistive system of FIG. 3 as detailed above from time to time. For example, before the child begins a brushing session, the camera 308 may be calibrated by checking whether one of the four extension faces of the extension device 304 is aligned with the bristle 402 of the toothbrush 306 and can be captured by the camera 308.

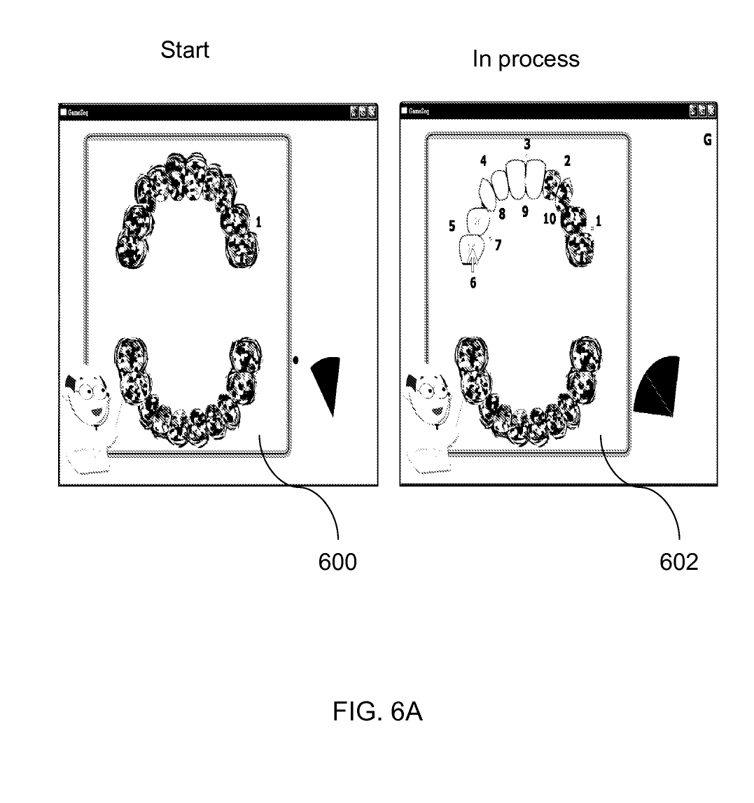

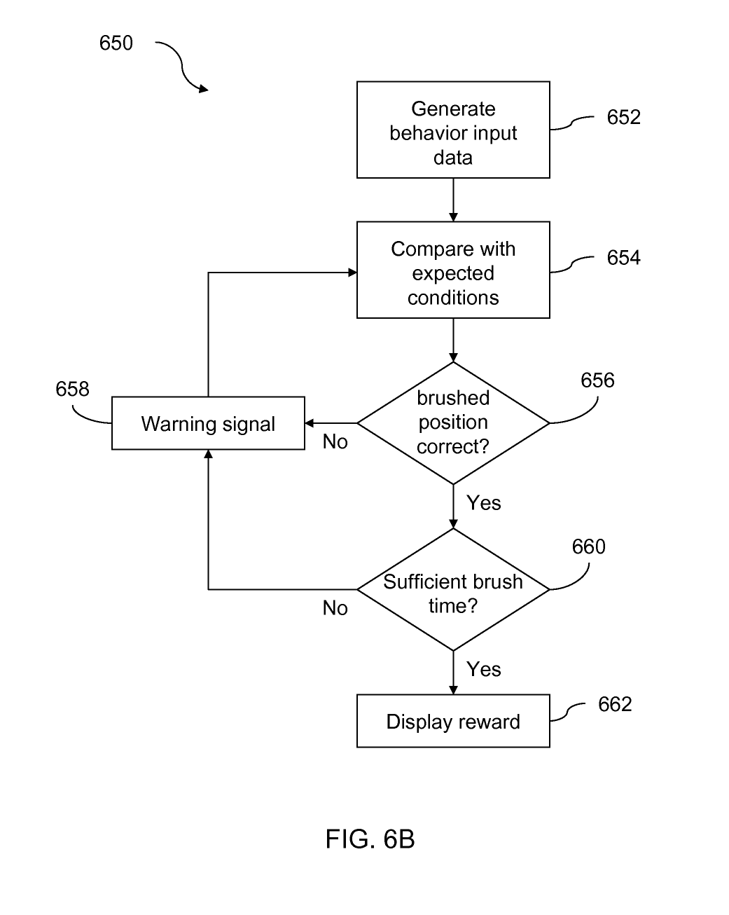

With the orientation and motion information of the signaling device 400 and optionally with the number of brush strokes, the behavior input data associated with a tooth brushing session can be generated. The behavior input data can then be fed into an interactive game, which is an application program executed by the computing device 310 of FIG. 3. FIG. 6A illustrates some display output images of such an interactive game, according to one embodiment of the present invention. Here, the interactive game is configured with a set of expected conditions corresponding to the ADA recommended tooth brushing routine. The interactive game may start with an image of a set of virtual dirty teeth as shown in a snapshot 600, which is displayed on the display device 312 for the child to see. The goal of the game is to guide the child to thoroughly clean these virtual dirty teeth as he or she physically brushes his or her own teeth. So, the interactive game is capable of taking the behavior input data from the child and mapping a physical brushing area where the child is brushing to the same brushing area in the virtual dirty teeth. For example, if the child is brushing the outer left group of teeth, then the corresponding outer left group of the virtual dirty teeth is shown to be brushed. One way to mimic dirty teeth is to display them with visible spots of plaque on the display device 312. If the child properly completes brushing certain physical brushing areas, the plaque on the corresponding brushing areas in the virtual dirty teeth is shown to fall off. This showing of plaque removal, such as shown in a snapshot 602, is one way to positively reward the child, so that he or she is motivated to continue the proper brushing technique. If the child brushes improperly (e.g., following an incorrect brushing sequence or not spending enough time on a particular brushing area), then either a neutral reward (e.g., the plaque is shown to remain) or even a negative reward (e.g. a warning signal is generated to alert the child to modify his or her brushing technique) is issued. By embedding the steps necessary to develop a desired brushing technique in the interactive game, the child can learn and develop the brushing technique from playing the interactive game.

FIG. 6B is a flow chart illustrating a process that the assistive system of FIG. 3 follows, according to one embodiment of the present invention. After the computing device 310 determines the orientation and motion information associated with the toothbrush 306 and the extension device 304 and optionally also the number of the brush strokes from the captured image data from the camera 308, it proceeds to generate behavior input data in step 652 and execute the aforementioned interactive game to compare this behavior input data with the ADA recommendations in step 654. In step 656, if the computing device 310 determines that the child is physically brushing a brushing area that does not adhere to the ADA recommended brushing routine in step 656, then in one implementation, the computing device 310 generates a warning signal in step 658 to notify the child to modify his or her tooth brushing technique. For instance, the child may be prompted via the display device 312 to brush a different brushing area. On the other hand, if the child physically brushes the ADA recommended brushing area, then the computing device 310 may count the number of the brush strokes and compare to a certain threshold. If the computing device 310 determines that the child fails to brush the brushing area for a sufficient amount of time in step 660, it also issues a warning signal in step 658 to inform the child to spend more time brushing that particular brushing area. If both the tooth brushing position and the time spent on it are in compliance with the expected conditions, then the computing device 310 issues the child a reward in step 662 by displaying the removal of plaque on the display device 312. As has been shown, by utilizing the feedback reward model as described above, a child is likely to pay attention to how he or she brushes teeth and consequently learn and acquire the proper tooth brushing technique.

The above description illustrates various embodiments of the present invention along with examples of how aspects of the present invention may be implemented. Some aspects of the present invention may be implemented as a program product for use with a device. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, DVD disks readable by a DVD driver, ROM chips, or any type of solid-state non-volatile semiconductor memory) on which information is permanently stored; and (ii) writable storage media (e.g., floppy disks within a diskette drive, hard-disk drive, CD-RW, DVD-RW, flash memory, or any type of random-access memory) on which alterable information is stored. The above examples, embodiments, instruction semantics, and drawings should not be deemed to be the only embodiments, and are presented to illustrate the flexibility and advantages of the present invention as defined by the following claims.

We claim:

1. An assistive system for developing a tooth brushing technique, comprising:
a signaling device;
a detection device configured to capture a plurality of patterns coded on the signaling device during a tooth brushing session; and
a computing device configured to derive motion and orientation information associated with the signaling device based on the plurality of patterns, formulate behavior input data according to the motion and orientation information, and generate a reward based on the motion and orientation information and also a predetermined set of expected conditions that correspond to the tooth brushing technique, wherein the reward is tailored to promote learning of the tooth brushing technique.

2. The assistive system of claim 1, wherein the signaling device further includes an extension device having a set of markers that make up the plurality of patterns.

3. The assistive system of claim 2, wherein the set of markers are light emitting diodes with predetermined colors that are on the extension device in predetermined locations.

4. The assistive system of claim 1, wherein the detection device is a camera configured to capture the plurality of patterns so long as the signal device is within a detection range of the camera.

5. The assistive system of claim 1, further comprising a supplemental detection device capable of recording the motion and orientation information the signaling device for non-real time analysis.

6. The assistive system of claim 1, wherein the computing device is further configured to establish the orientation information from tracking a first angle associated with the signaling device along a horizontal axis and second angle also associated with the signaling device along a vertical axis in a three-dimensional coordinate system.

7. The assistive system of claim 1, wherein the computing device is further configured to establish the motion information from tracking a brush motion vector displacement and a direction of the brush motion vector associated with the signaling device.

8. The assistive system of claim 1, wherein the computing device is further configured to track a number of brushing strokes for cleaning a brushing area.

9. The assistive system of claim 1, further comprising a display device, wherein the computing device is configured to execute an application program that displays the reward to a user of the signaling device on the display device.

10. A signaling device for assisting a child to develop a tooth brushing technique, comprising:
a toothbrush; and
an extension device, affixed to the tooth brush, wherein the extension device is coded with a plurality of patterns that can be converted into motion and orientation information associated with the tooth brush in a tooth brushing session, and the motion and orientation information is further compared to a predetermined set of expected conditions that correspond to the tooth brushing technique to determine a reward tailored to promote learning of the tooth brushing technique.

11. The signaling device of claim 10, wherein the extension device further includes a plurality of extension faces, each having a set of markers on it.

12. The signaling device of claim 11, wherein the set of markers conveys color and location information.

13. The signaling device of claim 12, wherein the color and location information is used to establish the orientation information by tracking a first angle associated with the toothbrush along a horizontal axis and second angle also associated with the toothbrush along a vertical axis in a three-dimensional coordinate system.

14. The signaling device of claim 12, wherein the color and location information is used to establish the motion information by tracking a brush motion vector displacement and a direction of the brush motion vector associated with the signaling device.

15. The signaling device of claim 12, wherein the color and location information is used to track a number of brushing strokes for cleaning a brushing area.

16. A computer-readable medium containing a sequence of instructions, which when executed by a processing unit of a computing device in an assistive system, causes the processing unit to:
derive motion and orientation information associated with a signaling device based on image data captured in a tooth brushing session, wherein the image data includes a plurality of patterns coded on the signaling device,
formulate behavior input data according to the motion and orientation information, and
generate a reward based on the motion and orientation information and also a predetermined set of expected conditions that correspond to a tooth brushing technique, wherein the reward is tailored to promote learning of the tooth brushing technique.

17. The computer readable medium of claim 16, wherein the plurality of patterns includes color and location information associated with a set of markers on the signaling device.

18. The computer readable medium of claim 17, further comprising a sequence of instructions, which when executed by the processing unit, causes the processing unit to use the color and location information to establish the orientation information associated with the signaling device from tracking a first angle associated with the signaling device along a horizontal axis and second angle also associated with the signaling device along a vertical axis in a three-dimensional coordinate system.

19. The computer readable medium of claim 17, further comprising a sequence of instructions, which when executed by the processing unit, causes the processing unit to use the color and location information to establish the motion information from tracking a brush motion vector displacement and a direction of the brush motion vector associated with the signaling device.

20. The computer readable medium of claim 16, further comprising a sequence of instructions for an application program, which when executed by the processing unit, causes the processing unit to display the reward to a user of the signaling device.
